(19) United States
(12) Patent Application Publication
(10) Pub. No.: US 2020/0108722 A1
(43) Pub. Date: Apr. 9, 2020

(54) OPERATING PROCEDURE FOR A BRAKE SYSTEM, BRAKE SYSTEM AND MOTOR VEHICLE

(71) Applicant: AUDI AG, Ingolstadt (DE)

(72) Inventors: Kai VOLKMAR, Gaimersheim (DE); Stephan LASSENBERGER, Neuhausen (DE)

(73) Assignee: AUDI AG, Ingolstadt (DE)

(21) Appl. No.: 16/568,659

(22) Filed: Sep. 12, 2019

(30) Foreign Application Priority Data
Oct. 8, 2018 (DE) 10 2018 217 121.1

(51) Int. Cl. B60L 7/26; B60T 8/17

(52) U.S. Cl. CPC B60L 7/26; B60T 13/586; B60T 8/17

(57) ABSTRACT

An operating procedure for a brake system of a motor vehicle, wherein the brake system comprises a friction brake and a regenerative brake, wherein the driving situation (F) is evaluated with regard to the use of the regenerative brake in the case of a braking, wherein, as a function of the result of the evaluation (A), a distribution function (D) is specified for the distribution of a braking torque (M) to the friction brake and to the regenerative brake.

### FIELD

The disclosure relates to an operating procedure for a brake system for a motor vehicle, wherein the brake system comprises both a friction brake and also a regenerative brake. The invention moreover relates to such a brake system as well as to a motor vehicle with such a brake system.

### BACKGROUND

A motor vehicle with a regenerative (recuperative) brake can use this brake in order to convert kinetic energy into electrical energy and store it in a battery. Here, the motor vehicle is decelerated (braked). In particular, the regenerative brake is an electric machine (E machine) which is operated as a generator.

In addition to the regenerative brake, the motor vehicle typically has a friction brake, in particular a friction brake which can be actuated hydraulically. Here, the kinetic energy is dissipated and can consequently not be stored for later use.

In the case of braking, a target delay and/or a target braking torque determined therefrom and bringing about the target delay is/are specified. For example, this target delay or braking torque is determined based on the position of a brake pedal or is specified by the driving assistance function when a driving assistance function is used. The target delay or the target braking torque is generated here, for example, by the use both of the regenerative brake and also of the friction brake. Thus, the friction brake and the regenerative brake each contribute a portion to the target delay or to the target braking torque.

These portions of the target braking torque of the respective brake are referred to in brief as portions below. They are determined here by a distribution function also referred to as “brake blending” and applied accordingly. For example, in a so-called subtractive blending, the deceleration portion of the regenerative brake is subtracted from the desired target deceleration, and the remaining portion is generated by means of the friction brake.

However, in the determination of the respective portions, multiple targets compete with one another. On the one hand, the braking should be as energy efficient as possible, i.e., the regenerative brake portion should be as large as possible. For example, the regenerative brake portion is selected to be static, i.e., constant, for the entire temporal braking profile. In particular, the static regenerative brake portion is selected here in such a manner that the braking process is felt to be comfortable by the driver and is safe, i.e., an insufficient or temporally delayed braking effect should be avoided. For this purpose, in particular depending on operation and/or design conditions, it is necessary that a suboptimal operation with regard to energy efficiency occurs.

Typically, the dynamics of a regenerative brake, for example, of an electric machine operated as a generator, is lower than the dynamics of the friction brake. Here, dynamics of a brake is understood to mean the temporal changeability of the braking torque generated by this brake or the delay. A relatively large change of the target braking torque or of the target delay can thus not be brought about only by means of this regenerative brake. Thus, at the end of the braking process (end of braking), due to the relatively low dynamics, the braking effect of the regenerative brake is reduced relatively slowly. Consequently, the speed of the vehicle continues to decrease after the end of braking, which is also referred to as “follow-up braking.” On the one hand, the regenerative brake portion should be relatively high. However, if the regenerative brake portion is selected to be relatively high, then, however, this follow-up braking is perceivable to a driver and felt to be uncomfortable by said driver. The static regenerative brake portion is consequently selected to be smaller, wherein a suboptimal operation with regard to the energy efficiency occurs.

### SUMMARY

The invention is based on the problem of indicating an operating procedure for a braking system, wherein, taking into consideration the driving situation and/or a feeling of comfort of a driver, a braking process occurs in as recuperative a manner as possible. Moreover, such a braking system and a motor vehicle with such a braking system are to be indicated.

Advantageous embodiments and developments are the subject matter of the dependent claims. Here, the explanations in connection with the procedure as appropriate also apply to the braking system and to the vehicle and vice versa.

The operating procedure is provided and suitable for a brake system with a regenerative brake, also referred to as regeneratively delaying actuator, and with a friction brake. Here, in particular a motor vehicle comprises the brake system.

In a first step, the driving situation, in particular the current driving situation, is evaluated with regard to the use of the regenerative brake in the case of braking (braking process). Preferably, the driving situation is classified during the course of the evaluation.

Here, a driving situation is understood to mean in particular the traffic situation which can be perceived objectively by the driver. For example, this includes a behavior and the spatial position of the traffic participants as well as parameters influencing the traffic such as, for example, a traffic density or the weather.

In a second step, as a function of the result of the evaluation or the classification, a distribution function for the distribution (allocation) of a braking toque (braking torque) to the friction brake and to the regenerative brake is specified. For this purpose, the distribution function is selected, for example, on the basis of the classification, for example, from a stored table. The braking torque here is, in particular, the independent variable of the distribution function.

In the case of braking (a braking process), a target braking torque is specified. Said target braking torque is used for the distribution function as braking torque, that is to say in particular as the independent variable. On the basis of the specified distribution function, correspondingly a portion of the target braking torque associated with the friction brake and a portion of the target braking torque associated with the regenerative brake are determined. These portions associated with the friction brake and with the regenerative brake are taken over by the respective brake, so that the motor vehicle is braked. In other words, during a braking, the specified distribution of the target braking torque is applied, that is to say the portions of the target braking torque are generated by the respective brake.

For example, the target braking torque is specified by the driver by means of a brake pedal position or directly by a driving assistance function which is configured, for example, for the autonomous driving of the motor vehicle.

In any case, the target braking torque is here equal to the sum of the portion associated with the friction brake and the portion associated with the regenerative brake. Preferably, a corresponding (wheel) portion of the portion of the target braking torque associated with the friction brake or with the regenerative brake is moreover associated here with each wheel of the motor vehicle.

Alternatively to the target braking torque, for example, a target delay is specified, by means of which the target braking torque is determined.

In particular, the specified distribution function here is a function of time. Thus, the portions of the braking torque or of the target braking torque associated with the brakes can change during the course of the braking process.

Here the evaluation of the driving situation is repeated, for example, continuously or at temporally identical intervals. Alternatively, the evaluation is carried out when the driving situation changes. In another alternative, the evaluation occurs when the target braking torque is specified.

In particular, the braking should be perceived to be comfortable by a driver of the motor vehicle. Thus, for example, the follow-up braking referred to at the beginning should not occur or should be tolerable. In addition, the braking process should be safe, i.e., an insufficient or temporally delayed braking effect should be avoided. Preferably, this is taken into consideration in the evaluation as a comfort criterion or as a safety criterion.

Preferably, the regenerative brake portion is specified to be as high as possible, in particular taking into consideration the comfort and/or the safety criterion.

Due to both the time dependency and also the specification of the distribution function as a function of the result of the evaluation and thus as a function of the driving situation, the distribution function is also referred to as “dynamic distribution function” or as “dynamic brake blending.”

Advantageously, due to the temporal variability of the regenerative brake and due to the specification of the distribution function as a function of the driving situation, the regenerative brake portion is relatively high, in particular higher than in the static specification of this portion, referred to at the beginning, without conflicting with the comfort or the safety criterion. The operation of the motor vehicle including the braking system is thus advantageously improved with regard to energy efficiency.

According to a suitable development, for the evaluation, an expected braking profile, i.e., an expected temporal course of the braking torque is determined (predicted). For example, it is determined here whether it should be expected that the speed of the vehicle only decreases (adaptive braking) during the course of the braking, or whether a braking (a slowdown) to a standstill of the motor vehicle (braking to a stop) occurs.

In particular, in comparison to the friction brake, the regenerative brake has a lower dynamics, that is to say a lower temporal changeability with respect to the (recovery) braking torque generated thereby. In the case of braking to a stop, such a relatively low dynamics is perceived relatively little or not at all by the driver, so that the comfort criterion is here satisfied in any case. Advantageously, the distribution function can or is specified in such a manner that the regenerative brake portion of the target braking toque is correspondingly high when a braking to a stop is expected.

In any case, during the taking over of the regenerative brake portion, the safety criterion is taken into consideration. Thus, for example, in the case of a relatively high specified target braking torque, that is to say in the case of emergency braking, the portion of the target braking torque which associated with the friction brake is set correspondingly high.

According to an advantageous embodiment, for the evaluation, an expected braking duration is determined. This expected braking duration is used, for example, directly for the evaluation. In addition or alternatively, the expected braking duration is used for the determination of the expected braking profile. In the distribution function, a temporal course, dependent on the expected braking duration, of the portion of the braking torque which is associated with the regenerative brake is used and then specified. In other words, the distribution function is selected in such a manner that the portion of the braking torque or correspondingly of the target braking torque, which is associated with the regenerative brake, is temporally variable, wherein this portion is dependent on the expected braking duration.

For example, in the case of braking, the regenerative brake portion is selected as high as possible as a function of the expected braking duration. Here, advantageously, the temporal course of the regenerative brake portion is specified as a function of the braking duration in such a manner that in the case of the change of the target braking torque as well, the braking is not perceived as unpleasant by the driver. For this purpose, for example, the friction brake portion is selected to be sufficiently high so that, in the case of a change of the target braking torque, a sufficient dynamics of the braking torque is generated, so that the follow-up braking, referred to at the beginning, is relatively small and still tolerated by the driver.

Analogously, in the case of a correspondingly expected braking duration, a temporal course of the friction brake portion is specified as a function of the braking duration. Typically, the target braking torque changes relatively rapidly at the beginning of braking and/or at the end of braking. Since the dynamics of the regenerative brake is lower than that of the friction brake, the friction brake portion is therefore specified as correspondingly high in the case of a relatively short expected braking duration. Consequently, the target braking torque can be generated at the beginning of braking and at the end of braking.

According to an advantageous design, based on the expected braking duration, an end of braking is determined. In particular, for this purpose, in the case of braking, the expected braking profile and the time of the beginning of braking are used. Here, the portion allocated to the regenerative brake is reduced toward the end of braking. In other words, the distribution function is specified in such a manner that the portion allocated to the regenerative brake is temporally variable, wherein this portion is reduced toward the end of braking.

Preferably, the regenerative brake portion of the braking torque is reduced from a maximum toward the expected end of braking, wherein, as maximum, the braking torque itself is used to the extent possible. For example, depending on design conditions, operation conditions and/or in order to take into consideration the safety criterion, the regenerative brake portion is smaller than the braking torque. In summary, the regenerative brake portion is relatively large for a relatively long time period, so that the motor vehicle is operated particularly energy efficiently. In summary, an expected braking profile and/or an expected braking duration can be used for the evaluation. However, the expected braking duration and/or the expected braking profile can deviate from an actual braking duration and/or from an actual braking profile. Therefore, the distribution of the target braking torque to the friction brake and to the regenerative brake based on the distribution function is always specified in such a manner that the safety criterion is maintained. Furthermore, the distribution is preferably specified in such a manner that, even in the case of such a deviation, the possibly relatively low dynamics of the brakes is not perceived or is perceived as still tolerable by the driver.

Even if such deviations occur, due to the dynamic distribution function, the regenerative (recuperative) portion is advantageously relatively high, at least in the statistic mean.

For the determination of the expected braking profile and/or for the determination of the braking duration, environmental data are used according to a suitable design. Additionally or alternatively, the environmental data is used directly for the evaluation, for example, as a variable.

The environment data preferably includes high-resolution map data, in which, for example, the position of traffic lights and stop signs as well as route information such as, for example, a slope of a road or a course of a curve are stored. Additionally or alternatively, the environmental data moreover includes data provided by a navigation system, for example, a destination or information on the selected route, such as, for example, the location of a road into which a driver turns.

Additionally or alternatively, the environmental data furthermore includes data of a sensor such as, for example, a distance sensor, a traffic sign detection, a traffic light detection, a priority traffic detection, an obstacle detection and/or data from the acquisition of traffic participants who are driving ahead. In addition or alternatively, the environmental data also comprises data from a communication interface, for example, from so-called car-2-X communication. Car-2-X communication is characterized in that, between the motor vehicle and another motor vehicle or an object, a communication connection is set up, via which the vehicle is exchanges data with the other vehicle or the object.

Additionally or alternatively, the environmental data moreover includes weather data, data on the road condition and/or a traffic density.

Alternatively or preferably, in addition to the environmental data, the habits of the driver, for example, routes typically driven, are taken into consideration.

For example, during the course of the determination of the expected braking profile and/or the expected braking duration, based on the environmental data, a stop position is determined, for example, because a stop sign or because a destination stored in the navigation system has been reached. Moreover, for example, based on the environmental data, a braking profile is predicted. Thus, it is detected that the speed of the motor vehicle should be reduced, for example, due to a speed limit, and what value the speed should be reduced to. Thus, an adaptive braking is expected.

According to an advantageous design, for the evaluation and/or for the determination of the braking profile and/or of the braking duration, a requirement of the dynamics of the braking torque with respect to the driving situation is used. Different driving situations have different requirements of the dynamics of the braking torque, that is to say the temporal changeability thereof. By means of the evaluation, the distribution of the braking torque to the friction brake and to the regenerative brake is specified in accordance with the dynamics requirement.

For example, a distinction is made between a comfort-based vehicle operation and a dynamic vehicle operation. In particular, during comfort-based vehicle operation, a driver has a relatively high tolerance with respect to a low dynamics. Accordingly, during dynamic vehicle operation, relatively high dynamics is necessary for the driving be perceived to be comfortable.

For the identification of the respective vehicle operation, for example, a temporal course of an acceleration in the vehicle transverse direction and/or in the vehicle longitudinal direction, the temporal course of a steering wheel position, of a pedal position and/or of the (gear selections, gears selected) gears, is used. A temporally relatively long trip at relatively high speed in a relatively high gear is, for example, a comfort-based vehicle operation.

In addition, the driver can select, for example, by means of additional operating elements, a driving mode, for example “a sports, assisted or autonomous driving mode,” wherein each of the driving modes applies a corresponding requirement of the dynamics of the braking torque.

Additionally or alternatively, for the identification of the vehicle operation and thus for the identification of the requirement of the dynamics, environmental data is used. In particular, the traffic flow and the route information are particularly suitable for this purpose.

In particular, the friction brake has a high dynamics and can generate a relatively high (dissipation) braking torque, as a result of which, for the evaluation, properties of the regenerative brake are substantially used. For the evaluation, advantageously the maximum achievable dynamics of the braking torque with use of the regenerative brake the maximum achievable braking torque with the use of the regenerative brake is used. For the evaluation, such properties or limitations are represented in particular by means of a corresponding maximum value.

Additionally or alternatively, these properties are used for the determination of the expected braking profile, the braking duration and the maximum from which the regenerative brake portion is reduced toward the end of braking.

The dynamics which can be generated by means of the regenerative brake and the (recovery) braking torque which can be generated by means of the regenerative brake or the portion of the braking torque which can be generated here depend on the design conditions and/or on the operation of the regenerative brake. These properties are, for example, known and stored in the control device and/or are determined by means of operating state variables of the regenerative brake. For example, by means of a regenerative brake which is designed as an electric machine with relatively low power, at relatively high speeds of the motor vehicle, only a relatively small portion of the target braking torque can be obtained. Moreover, for example, resilient parts of the regenerative brake can be excited so as to oscillate at a relatively high braking torque generated by said regenerative brake. To avoid this, for example, a corresponding maximum value of the braking torque generated by means of the regenerative brake is specified.

According to an advantageous development, a brake system of a motor vehicle comprises a friction brake and a regenerative brake as well as a control device. Here, the control device, designed, for example, as controller or microprocessor, is used for distributing the braking torque, in particular the specified braking torque, to the friction brake and to the regenerative brake according to the procedure in any of the above-represented variants. In particular, here, the driving situation is evaluated with regard to the use of the regenerative brake in the case of braking, and the distribution, in particular the temporally variable distribution, of the braking torque, is specified as a function of the result of the evaluation.

In an advantageous embodiment, a motor vehicle comprises such a brake system.

### BRIEF DESCRIPTION OF THE DRAWINGS

Below, an embodiment example of the invention is explained in greater detail in reference to a drawing. In the drawing:

FIG. 1 diagrammatically shows a motor vehicle with a brake system which comprises a friction brake, an electric machine which can be operated as regenerative brake and a control device,

FIG. 2 shows a flow chart of an operating procedure for the brake system, wherein a driving situation is evaluated with regard to the use of the regenerative brake,

FIG. 3a shows two temporal courses of a target braking torque and a temporal course of the portion of the target braking torque which is generated by the regenerative brake, and

FIG. 3b shows temporal courses of the speed of the motor vehicle corresponding to the temporal courses of the target braking torque and corresponding to the temporal course of the portion of the target braking torque which is generated by the regenerative brake according to FIG. 3a.

### DETAILED DESCRIPTION

Mutually corresponding parts and variables are always provided with the same reference numerals in all the figures.

In FIG. 1, a motor vehicle 2 is shown, which comprises an electric machine 4 and which is, for example, a hybrid vehicle. The electric machine 4 is designed to generate a (recovery) braking torque M_{reg} in the generator operation. Correspondingly, the electric machine 4 is connected via a power train of the motor vehicle 2, not shown in further detail, to a running gear 6 of the motor vehicle 2. In this manner, the electric machine 4 can be used for slowing (for braking) the motor vehicle 2. As energy source for the electric machine 4, the motor vehicle 2 comprises a battery 8 which is charged in the generator operation of the electric machine 4. In summary, the electric machine 4 in the generator operation is a regenerative (recuperative) brake. In addition to said regenerative brake, the motor vehicle 2 comprises a friction brake 10 for the generation of a (dissipation) braking torque M_{fric}.

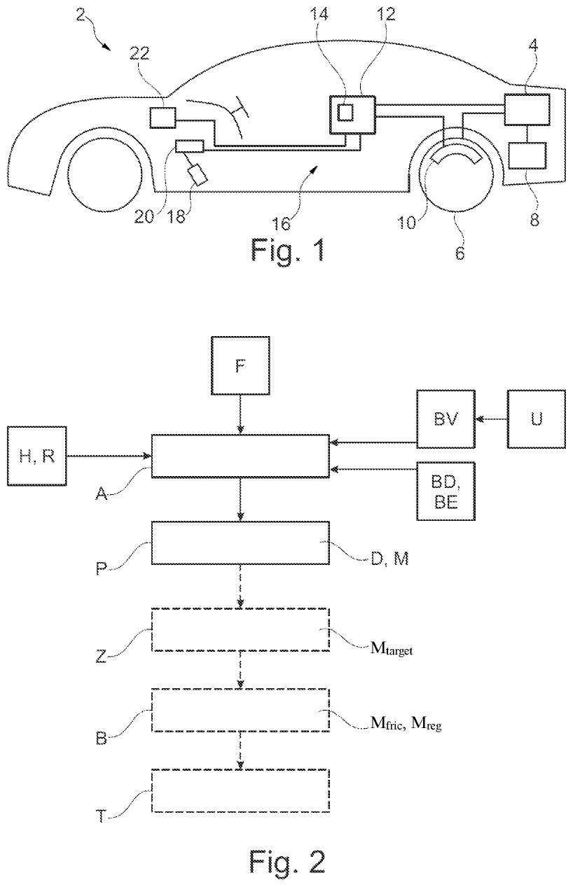

The motor vehicle 2 is designed to be controlled by means of a special procedure as shown in FIG. 2. For this purpose, the motor vehicle 2 comprises a control device 12. In the design of FIG. 1, the vehicle 2 in addition comprises a (automatic drive) driving assistance function 14 which is a part of the control device 12 in the embodiment example shown.

The electric machine 4, the friction brake 10 and the control device 12 together form a brake system 16.

In the case of braking, a braking torque referred to as target braking torque M_{ges} is specified. It is specified, for example, by the driving assistance function 14 or determined on the basis of a pedal position of a brake pedal 16 which can be actuated by a driver. For this purpose, the brake pedal 18 comprises a measuring device 20 that acquires the pedal position.

The target braking torque M_{target} brings about the braking, in particular a deceleration, of the motor vehicle 2. Here, in the case of sufficient dynamics of the recovery braking torque: M_{reg} M_{target}=M_{reg}+M_{fric}. Thus, the target braking torque is generated by means of the friction brake 10 and by means of the regenerative brake, here the electric machine 4 in the generator operation. Thus, by means of the brakes 4, 10, in each case a corresponding portion of the target braking torque M_{ges} is taken over.

Here, the dynamics of the regenerative brake designed as electric machine 4 is lower than the dynamics of the friction brake 10. In other words, the temporal changeability of the dissipation braking torque M_{fric} generated by means of the friction brake 10 is greater than that of the electric machine 4.

Moreover, the motor vehicle 2 comprises a communication interface 22 coupled to the control device 12, which, for example, enables a car-2-X communication.

In an alternative which is not represented in further detail, the motor vehicle 2 in addition comprises a sensor, for example, a distance sensor, or a traffic sign or traffic light detection.

In FIG. 2, in a flow chart, an operating procedure for the brake system 16 is represented. Here, in a first step, referred to as evaluation A, the current driving situation F is evaluated with respect to the use of the regenerative brake 4 in the case of braking. For this purpose, the driving situation is classified.

Subsequently, as a function of the result of the evaluation A, a distribution function D is specified (specification step P), which specifies a distribution of a braking torque M, supplied to this function in particular as an independent variable, to the friction brake 10 and to the regenerative brake 4. For this purpose, the distribution function D, according to this embodiment example, based on the classification of the driving situation, is selected from a table stored, for example, in the control device 12.

In the case of braking, the target braking torque M_{target} is specified. The target braking torque M_{target} is supplied to the distribution function D (specification and supply step Z). This step and the following steps are represented by a dashed line in FIG. 2, since they are carried out only in the case of braking. In this manner, a portion M_{fric} of the target braking torque M_{target}, associated with the friction brake 10, and a portion M_{reg} of the target braking torque M_{target}, associated with the regenerative brake 4, are determined (determination step B).

Subsequently, in a step of the procedure referred to as takeover step T, the portions M_{reg} and M_{fric} are taken over by the respective brake 4 and 10.

The evaluation A and the specification step P are repeated according to this embodiment example at equally spaced time intervals.

For the evaluation A, a maximum achievable dynamics of the braking torque M and a maximum achievable braking torque M are used, which can be achieved with use of the regenerative brake 4. In this manner, design- and/or operation-related limitations of the regenerative brake 4 with respect to the dynamics and the maximum amount of the braking torque M are taken into consideration. For this purpose, for the evaluation A, a corresponding maximum value for the regenerative brake portion of the braking torque M is provided, which maximum value H is stored in and/or determined by the control device 12.

In addition, for the evaluation A, an expected braking profile BV is determined. For this purpose, in particular environmental data U such as, for example, a traffic density, a position of a traffic light and/or a speed limit is/are used. They are received by means of the communication interface 22 or by the sensor.

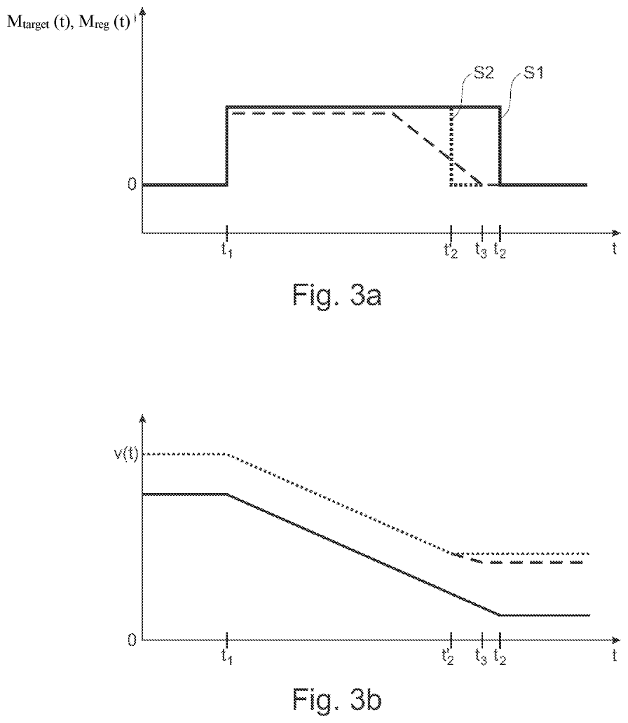

Thus, in the case of a speed limit, an adaptive braking is determined as expected braking profile BV, during which adaptive braking, the speed v of the motor vehicle 2 is correspondingly reduced (FIG. 3b).

Moreover, for the evaluation A, an expected braking duration BD is determined. The distribution function D is selected in such a manner that the portion of the braking torque M or, in the case of braking, the portion of the braking torque M_{target}, which is associated allocated to the regenerative brake 4 is reduced toward the end of the braking duration BD or in the case of the braking toward the end of braking determined by means of the braking duration BE.

In addition, for the evaluation A, a requirement R of the dynamics of the braking torque M for the current driving situation is used. In the case of a relatively high speed v of the motor vehicle 2, as represented as an example in FIG. 3a, and in the case of temporally lasting use of a high gear (of the gear shift), a comfort-based vehicle operation is expected. In said vehicle operation, the requirement R of the dynamics, which is represented here by means of a maximum value of the regenerative brake portion 4, is relatively low.

In FIG. 3a, two temporal courses of the target braking torque M_{target} are represented. The first of them is represented with a solid line and provided with the reference numeral S1. The second course is represented with a dotted line and provided with the reference numeral S2. These courses correspond to an adaptive braking, during which the speed v of the motor vehicle 2 is reduced, wherein the speed v is greater than zero at the end of braking. At time t₁, the braking process starts. The target braking torque M_{target} during the braking process is greater than zero. The braking process ends in the temporal course represented by the solid line at time t₂ and in the case of the course represented by a dotted line at time t₂′.

The regenerative brake portion M_{reg} of the target braking torque M_{target} is represented here with a dashed line. The portion M_{reg} at the beginning of the braking process is selected to be as high as possible, taking into consideration a safety criterion and taking into consideration the maximum value H, so that the motor vehicle 2 is operated in an energy efficient manner. The end of braking BE is here expected at time t₃. Toward the expected end of braking BE, the portion M_{reg} is reduced. Here, the end of braking BE or the time t₃ occurs temporally before and respectively temporally after the times t₂ and respectively t₂′.

In FIG. 3b, the corresponding speed courses are shown. Here, the speed course represented with a solid line corresponds to a speed course corresponding to a deceleration with the target braking torque M_{target} corresponding to the course S1 of FIG. 3a. This speed course also generated in the temporal course of the portion M_{reg} of the target braking torque shown in FIG. 3a if the expected end of braking BE occurs at the time t₃ before the actual end of braking t₂, as in the temporal course of the target braking torque M_{target} marked by S1 (FIG. 3a). Here, the difference between target braking torque M_{target} and the portion M_{reg} is generated by means of the relatively dynamic friction brake, so that the high temporal change of the target braking torque M_{target} can be generated.

The speed course of FIG. 3b, represented with a dotted line, corresponds to a deceleration with the target braking torque M_{target} corresponding to the course S2 of FIG. 3a. The speed course represented with a broken line corresponds to a deceleration in which the target braking torque M_{target} corresponding to the course S2 is specified, wherein, by means of the regenerative brake 4, the braking torque M_{reg} corresponding to the course represented with a broken line in FIG. 3a is generated.

Here, the target braking torque M_{target} is already equal to zero before the expected end of braking BE at time t₃. Due to the relatively low dynamics of the regenerative brake 4, the speed v of the motor vehicle 2 continues to decrease after t₃, which is referred to as follow-up braking or follow-up braking effect. Here, due to the reduction of the portion M_{reg} toward the expected end of braking BE, the follow-up braking effect is relatively small. In other words, at time t₃, the difference between the actual speed (course represented with a dashed line) and the speed during deceleration corresponding to the target braking torque M_{target} (dotted course) is relatively small. As a result, the follow-up braking is not perceived as interfering or uncomfortable by the driver of the motor vehicle 2.

The invention is not limited to the above-described embodiment example. Instead, other variants of the invention can also be derived therefrom by the person skilled in the art, without going beyond the subject matter of the invention. Furthermore, in particular, all the individual features described in connection with the embodiment example can also be combined in another manner with one another, without going beyond the subject matter of the invention.

1. An operating procedure for a brake system of a motor vehicle, wherein the brake system comprises:
a friction brake and a regenerative brake,
wherein the driving situation (F) is evaluated, in particular classified, with regard to the use of the regenerative brake in the case of a braking,
wherein, as a function of the result of the evaluation (A), a distribution function (D) is specified for the distribution of a braking torque (M) to the friction brake and to the regenerative brake,
wherein, in the case of a braking, a target braking torque (M_{target}) is specified and used as braking torque (M) for the distribution function (D),
wherein, on the basis of the distribution function (D), a portion (M_{fric}) of the target braking torque (M_{target}) associated with the friction brake and a portion (M_{reg}) of the target braking torque (M_{target}) associated with the regenerative brake are determined, and
wherein these portions (M_{reg}, M_{fric}) are taken over by the respective brake.

2. The operating procedure according to claim 1, wherein for the evaluation (A), an expected braking profile (BV) is determined.

3. The operating procedure according to claim 1, wherein for the evaluation (A), an expected braking duration (BD) is determined, wherein, in the distribution function (D), a temporal course of the portion of the braking torque (M) associated with the regenerative brake is used, temporal course which is dependent on the braking duration (BD).

4. The operating procedure according to claim 3, wherein in the case of a braking, an end of braking (BE) is determined on the basis of the expected braking duration (BD), and
the portion of the braking torque (M) associated with the regenerative brake is reduced toward the end of braking (BE).

5. The operating procedure according to claim 2, wherein environmental data (U) is used for the determination of the expected braking profile (BV) and/or of the braking duration (BD).

6. The operating procedure according to claim 1, wherein for the evaluation (A), a requirement (R) of the dynamics of the braking torque (M) with regard to the driving situation (F) is used.

7. The operating procedure according to claim 1, wherein for the evaluation (A), the dynamics of the braking torque (M) which can be generated during the use of the regenerative brake is used.

8. The operating procedure according to claim 1, wherein for the evaluation (A), the maximum braking torque (M) which can be generated during the use of the regenerative brake is used.

9. A brake system of a motor vehicle, with a friction brake and with a regenerative brake as well as with a control device for the distribution of the target braking torque (M_{target}) to the friction brake and to the regenerative brake.

10. The operating procedure according to claim 2, wherein for the evaluation (A), an expected braking duration (BD) is determined, wherein, in the distribution function (D), a temporal course of the portion of the braking torque (M) associated with the regenerative brake is used, temporal course which is dependent on the braking duration (BD).

11. The operating procedure according to claim 3, wherein environmental data (U) is used for the determination of the expected braking profile (BV) and/or of the braking duration (BD).

12. The operating procedure according to claim 4, wherein environmental data (U) is used for the determination of the expected braking profile (BV) and/or of the braking duration (BD).

13. The operating procedure according to claim 2, wherein for the evaluation (A), a requirement (R) of the dynamics of the braking torque (M) with regard to the driving situation (F) is used.

14. The operating procedure according to claim 3, wherein for the evaluation (A), a requirement (R) of the dynamics of the braking torque (M) with regard to the driving situation (F) is used.

15. The operating procedure according to claim 4, wherein for the evaluation (A), a requirement (R) of the dynamics of the braking torque (M) with regard to the driving situation (F) is used.

16. The operating procedure according to claim 5, wherein for the evaluation (A), a requirement (R) of the dynamics of the braking torque (M) with regard to the driving situation (F) is used.

17. The operating procedure according to claim 2, wherein for the evaluation (A), the dynamics of the braking torque (M) which can be generated during the use of the regenerative brake is used.

18. The operating procedure according to claim 3, wherein for the evaluation (A), the dynamics of the braking torque (M) which can be generated during the use of the regenerative brake is used.

19. The operating procedure according to claim 4, wherein for the evaluation (A), the dynamics of the braking torque (M) which can be generated during the use of the regenerative brake is used.

20. The operating procedure according to claim 5, wherein for the evaluation (A), the dynamics of the braking torque (M) which can be generated during the use of the regenerative brake is used.
